(19) United States
(12) Patent Application Publication
(10) Pub. No.: US 2004/0128347 A1
(43) Pub. Date: Jul. 1, 2004

(54) System and method for providing content access at remote portal environments

(76) Inventors: Jeffrey Mason, Wantage, NJ (US); Venkata Gandra, Edison, NJ (US); Christopher Venter, Berkeley Heights, NJ (US)

Correspondence Address: WOLFF & SAMSON, P.C., ONE BOLAND DRIVE, WEST ORANGE, NJ, 07052, US

(21) Appl. No.: 10/334,304

(22) Filed: Dec. 31, 2002

(51) Int. Cl. G06F 15/16

(52) U.S. Cl. 709/203; 709/218

(57) ABSTRACT

A system and method for providing remote content access in portal environments operating on is provided. A portal environment executing in a web browser on a local computer (e.g., a laptop, PC, or PDA) allows access to local and remote applications and data. Local and remote applications from multiple vendors are integrated using an application integration service, and access thereto is provided in the portal environment. A portal services module handles requests generated by the user from the portal environment, and determines whether the user is online or offline. If the user is online, a remote portal catalog is downloaded from a remote server, and dates therein are compared to file dates of the requested content to determine whether the local content is out of date. If the local content is out of date, updated versions of the content are downloaded from the remote server to update the local content. The updated content is provided to the user, and is accessible when the user is both online and offline.

### BACKGROUND OF THE INVENTION

1. Field of the Invention

The present invention relates to a system and method for providing content access in remote portal environments. More specifically, the invention relates to a system and method for providing access to data and applications residing on both local and remote machines via a portal environment that automatically detects connectivity (e.g., online/offline) status, integrates remote and local applications and data for use in a local portal, and automatically updates local content when an online condition is detected.

2. Related Art

Remote computing has quickly become a desirable way of accomplishing work at remote locations, using a variety of devices. For example, traveling employees frequently use mobile computing devices, such as laptops, to accomplish work while away from the office. Further, field representatives, consultants, and other individuals are often required to access central computer networks, applications, and data from remote sites. The vast majority of such remote computing systems allow not only for remote computing, but also allow network connectivity and communication. For example, most mobile computers include modems for allowing dial-up connectivity to the Internet, and often include networking cards (e.g., 10-Base-T, 100-Base-T) for allowing users to connect to public and private LANs, WANs, and other networks. Moreover, RF networking equipment, such as systems based on the Bluetooth standard, allows computer users to maintain mobile, untethered connectivity with wireless networks.

While remote computing technologies have, indeed, made it much easier to compute while traveling, the problem of delivering content to remote and/or mobile users still presents significant problems. For example, when a business user is traveling, he or she often requires access to data and applications residing remotely on enterprise networks and servers. In order to gain access to the remote applications and data, the user must gain access to the Internet, and must remain online during the period in which use of the remote applications and data is needed. This is frequently inconvenient, as mobile users often do not have access to the Internet and must remain offline and without required data and applications for extended periods of time.

Moreover, even if the user gains access to his or her remote applications and data, and downloads same to the local computer for use while offline, there presently is no effective system for dynamically updating content when the user is next online, unbeknownst to the user and not requiring any user intervention. Additionally, there presently does not exist any effective system for allowing access to both local and remote applications via a single, mobile, and intuitive interface (such as a portal environment), wherein data can be exchanged between multiple applications from multiple vendors and accessed via the interface.

The goal of seamlessly delivering content from enterprise networks and servers to remote users is especially critical with individuals involved in sales. Currently, when a salesperson desires to travel to a location to make a sales presentation or engage in a client meeting, such individual typically downloads content to a laptop or portable machine, travels to the location and gives the presentation. The problem with this approach is that the content given during the presentation is not the most current content available, as the user may be offline during the period before the presentation. Moreover, the salesperson is not provided with an effective means for accessing enterprise data and applications in a single, intuitive, and easy-to-use interface that allows the user to enter data into a plurality of applications. Rather, the salesperson is often required to enter data using a plurality of disparate applications at a local machine, and to later upload information to one or more enterprise systems. It would therefore be highly desirable to provide the salesperson with not only the ability utilize the most current content available, but also to provide access local and remote applications while in the field.

Accordingly, what would be desirable, but has not yet been provided, is a system and method for providing remote content access in portal environments, wherein online and offline access is provided to local and remote content and applications via a single user interface having a unified look-and-feel.

### SUMMARY OF THE INVENTION

The present invention relates to a system and method for providing content access in remote portal environments. A portal environment operating on a local computer (e.g., a laptop, PC, PDA, or other similar device) provides access to local and remote applications, and stores content locally. The environment interacts with an application integration service that allows local and remote applications from multiple vendors to exchange information using a plurality of application adapters. The application integration service is accessible via the portal environment, and both the portal environment and the application integration service allow the user to enter data into and retrieve data from the local and remote applications using a single, unified graphical user interface, without requiring the user to interact with numerous, disparate applications. Local and remote content is displayed in one or more portal pages that can be accessed via a standard web browser operating on the local machine. The local content is stored in one or more portal catalogs and files on the local system, and is dynamically updated when the user is online.

The present invention also provides a system and method for automatically determining when a user is online and dynamically updating local content for offline usage. The user's connectivity status is determined, and requests for files generated within the portal environment are monitored for. If the user is online, a remote portal catalog is downloaded from a remote system, and a local file corresponding to the requested file is compared to an entry in the downloaded portal catalog. If the local file is determined to be out of date, an updated file is downloaded from the remote server and stored locally for usage within the portal environment. The local portal catalog is updated to reflect the downloaded file, and the user can access the updated content while offline.

### BRIEF DESCRIPTION OF THE DRAWINGS

These and other important objects and features of the invention will be apparent from the following Detailed Description of the Invention, taken in connection with the accompanying drawings, in which:

FIG. 1 is a diagram showing the overall system architecture of the present invention.

FIG. 2 is a diagram showing interactions between the portal services module of the present invention, local and remote portal catalogs, and a plurality of XML, XSL, HTML, and portal configuration files.

FIG. 3 is a flowchart showing processing logic according to the present invention for monitoring user activity within a portal and handling file access requests.

FIG. 4 is a flowchart showing processing logic according to the present invention for providing content in response to user requests and automatically updating local content from one or more remote servers.

FIG. 5 is a flowchart showing processing logic according to the present invention for determining whether a user is online or offline and updating portal state information.

FIG. 6 is a diagram showing a preferred file structure for the portal service module configuration files of the present invention.

FIG. 7 is a diagram showing a preferred file structure for the application configuration files of the present invention.

FIG. 8 is a diagram showing a node structure according to the present invention for handling session object errors.

FIG. 9 is a diagram showing a node structure according to the present invention for handling file requests.

FIG. 10 is a diagram showing a preferred file structure for handling requests to the application integration services module of the present invention.

FIG. 11 is a diagram showing a preferred file structure for allowing automatic updating of local content.

FIG. 12 is a block diagram showing session-level and application-level cookies utilized by the present invention.

FIG. 13 is a diagram showing a sample portal layout.

FIG. 14 is a diagram showing the sample portal layout of FIG. 13, wherein both local and remote content and applications are accessible by the user.

FIGS. 15a-15s are flowcharts showing processing logic of the portal services module of the present invention.

### DETAILED DESCRIPTION OF THE INVENTION

The present invention relates to a system and method for providing content access in remote portal environments. A portal environment executable on a user's local computer system allows the user to interact with a plurality of applications and data sources, which can reside locally on the computer system, and/or remotely on one or more servers. Data and applications from multiple vendors are connected to the portal using an application service integration module and a plurality of application adapters. This provides data and applications that have the same structure, look, and feel, even though such data and applications may come from multiple vendors. Content can be stored locally on the user's machine, and remotely on one or more servers. The portal environment determines whether the use is online or offline, and automatically updates local content when the user is online for allowing offline access to content.

As used herein, the term “content” is intended to mean both data (including files, databases, tables, records, and other similar data structures) and applications. Further, as used herein, the terms “application integration” and “application integration service” refer to a system and method for allowing applications and data provided by disparate vendors to be used interchangeably. An example of such a system is described in detail in the co-pending U.S. patent application Ser. No. 10/039,981, filed Dec. 31, 2001 and assigned to the same assignee as the within application, the entire disclosure of which is expressly incorporated herein by reference (occasionally referred to therein, as well as herein, as the “Prudential Data Exchange” or “PDX” system). However, it is to be expressly understood that the present invention can operate with any application integration service known in the art, or hereinafter developed, and that such systems are all within the spirit and scope of the present invention.

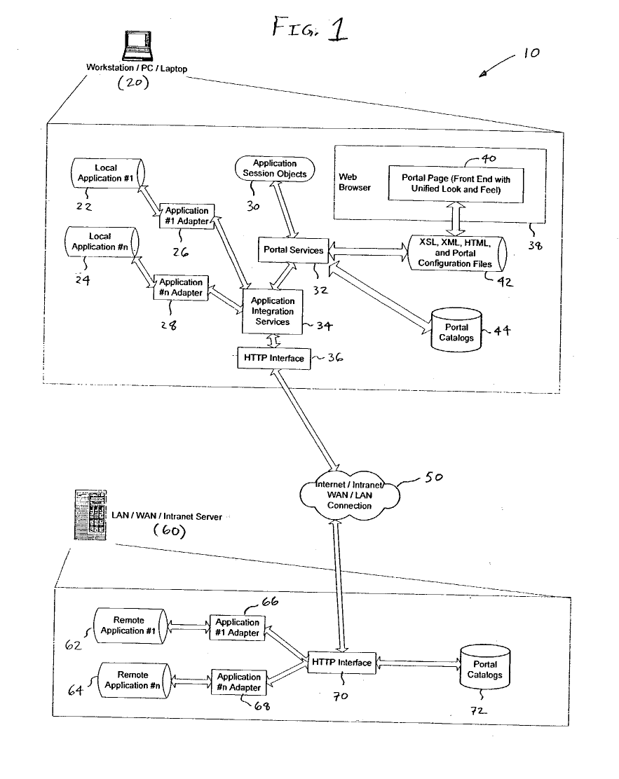

FIG. 1 is a diagram showing the overall system architecture of the present invention, indicated generally at 10. The present invention comprises a plurality of software components that operate on a local system 20 (such as a workstation, laptop, PC, PDA, or other similar device) and a remote system 60 (such as a LAN, WAN, Intranet, or Internet server). In a preferred embodiment of the present invention, local system 20 comprises a portable computing device, such as a laptop, having Internet connectivity and allowing connection to the remote system 60 via the Internet 50. Applications and data residing on the local system 20, in addition to applications and data residing on the remote system 60, are accessible via a web browser 38 executing on the local system 20.

Preferably, the web browser 38 includes a portal page 40 that provides the user with a portal environment having a unified look-and-feel and allowing access to remote and local content and applications. The portal page 38 runs in Microsoft's Internet Explorer, and allows the user to interact with one or more local applications, indicated illustratively as local applications 22 and 24, or remote applications 62 or 64. Of course, the portal page 38 could be executed in any other known web browser, such as Netscape Communicator, or a standalone application could be provided for presenting the portal to a user. The local applications 22 and 24 are connected to an application integration services module 34 via application adapters 26 and 28. Further, remote applications 62 and 64 are connected to the application integration services module 34 of the present invention via remote application adapters 66 and 68 and HTTP interface 70. In a preferred embodiment of the present invention, the application adapters 26, 28, 66, and 68, in addition to the application integration services module 34, comprise the aforementioned PDX application integration system. Importantly, the present invention is compatible with the PDX system, and provides a portal environment for interacting with same on a mobile platform.

A portal services module 32 is provided on the local system 20. The portal services module 32 contains logic, as will be described in greater detail below, for providing a number of tasks. Primarily, the portal services module 32 requests information from the application integration services module 34, and formats content provided by local or remote applications for presentation within the portal page 40. The portal services module 32 builds a response page within the portal of the present invention using HTML, XML, XSL, and portal configuration files 42. A plurality of configuration files are read by the portal services module 32, and indicate which HTML, XML, or XSL files to use in constructing the portal. Additionally, the portal services module 32 contains processing logic for determining whether a user is online (e.g., whether the local system 20 is connected to the Internet 50) or offline. If the user is online, the portal services module 32 communicates with an external server, such as the remote system 60, via HTTP interface 36 to acquire data and information from the external server. The HTTP interface 36 can be any interface known in the art, including, but not limited to, a dial-up account, TCP/IP connection, ISDN or DSL connection, cable modem, or wireless connection.

Importantly, the portal services module 32 of the present invention stores content in a local portal catalog 44. The portal catalog 44 allows the portal services module 32 to refresh content when the user is on-line by downloading the most recent content from the remote portal catalog 72 of the remote system 60, or other external source, via the HTTP interface 36 connected to the Internet 50. The downloaded content is stored in the local portal catalog 44 on the local system 20. In this fashion, when the user is next off-line, he or she is sure to be accessing the most current content available. This allows for the seamless transmission of content to the user regardless of whether the user is on-line or off-line. The portal services module 32 maintains session and application state information locally on the user's computer using session-level and application-level cookies. Importantly, to conserve bandwidth and network resources, the present invention updates only those local files that are determined to be out of date and which require updating.

The portal configuration files 42 are utilized by the present invention to manage the presentation and transmission of data through the portal. The files 42 contain information pertinent to each request for data, and provide application contexts so that the invention can be used with other applications. The portal configuration files track an application's local root location within the portal, in addition to one or more remote server names, locations, and IP addresses. This allows the portal services module 32 to communicate with one or more remote servers 60 to exchange content between the user's computer 20 and the remote server 60, in addition to allowing the aforementioned portal catalogs to be updated when the user is on-line. One or more application session objects 30 interact with the portal services module 32 of the present invention to allow the storage and retrieval of session information in one or more session-level cookies.

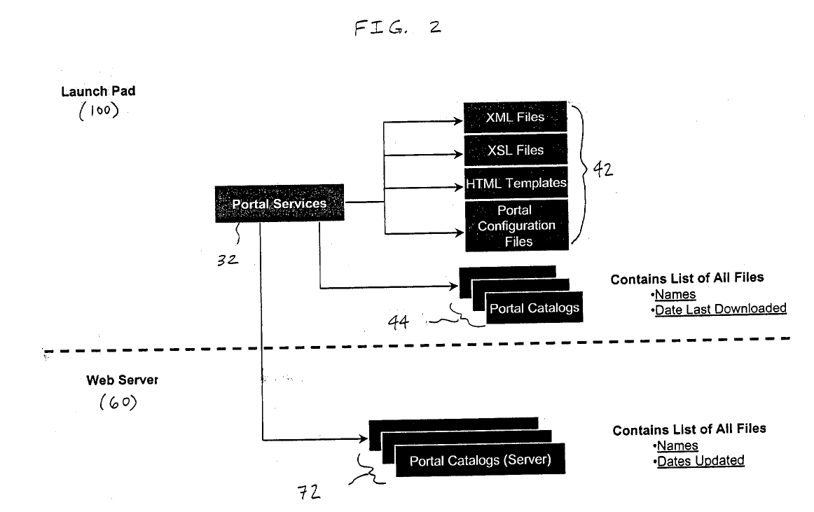

FIG. 2 is a diagram showing interactions between the portal services module 32 of the present invention, local and remote portal catalogs 44 and 72, and a plurality of XML, XSL, HTML, and portal configuration files 42. As mentioned earlier, the portal services module 32 of the present invention allows for remote and local content to be displayed by and accessed in a portal environment. This environment can be integrated into a launch pad application 100, such as the PDX launch pad application discussed in the co-pending application referenced earlier and incorporated herein by reference.

Importantly, the portal services module 32 delivers content to the portal using a plurality of XML, XSL, HTML, and portal configuration files 42. When the user is online, the portal services module 32 downloads the remote portal catalog 72, and compares same to file dates indicated in the local portal catalog 44. The file dates indicated in the local portal catalog 44 correspond to the file dates of the XML, XSL, HTML, and portal configuration files 42. If the file dates of the downloaded remote portal catalog 72 are newer (less than) the file dates indicated in the local portal catalog 44, the portal services module 32 downloads updated versions of the XML, XSL, HTML, and portal configuration files 42 from the remote server 60. If only a single file date is old, the portal service module 32 can selectively download only the corresponding file (e.g., if a date field in the local portal catalog 44 corresponding to a single XML file indicates that the single XML file is old, the portal service module 32 downloads only the newer version of the single XML file from the remote server 72). Once the updated files have been downloaded, the local portal catalog 44 is updated to reflect the newest file dates (e.g., the dates on which the updated files were downloaded). Thus, when the user is online, content stored locally is refreshed, and the local portal catalog 44 is updated to reflect the same. The update process occurs unbeknownst to the user, and the updated content is displayed by the portal services module 32 in the portal environment.

In the event that the user is offline, or if the file dates indicated in the local portal catalog 44 are not older than the file dates indicated by the remote portal catalog 72, the portal services module 32 utilizes local content stored in the XML, XSL, HTML, and portal configuration files 42 for display in the portal environment. Thus, as can be readily appreciated, each time the user is online, local content is dynamically updated so that when the user is next offline, the most recent content is available to the user. Such an approach expands the usefulness of portal environments operating on mobile platforms. The user is not required to be connected to the Internet, or other network, to use the portal environment, can interact with the environment when offline, and content can be dynamically updated when the user is next online.

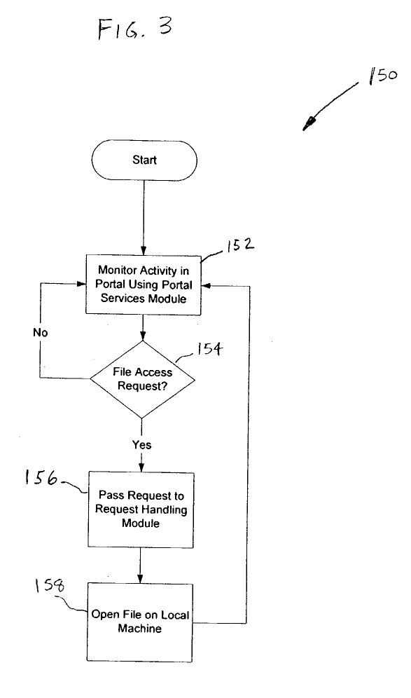

FIG. 3 is a flowchart showing processing logic, indicated generally at 150, for monitoring user activity within the portal environment and for handling file access requests. The processing logic disclosed herein can be implemented in any suitable computer language known in the art, such as JAVA by SUN MICROSYSTEMS, and on any suitable computer system known in the art, such as a laptop computer having an INTEL microprocessor. Beginning in step 152, the portal environment of the present invention is monitored by the portal services module 32 for user activity. For example, in this step, the portal page 40 executing in the web browser 38 of FIG. 1 could be monitored by the portal service module 32 for events triggered therein by a user at the local system 20. An example of such an event could include, but is not limited to, a mouse click on a hypertext (HTML) link appearing within the portal page 40 displayed by the web browser 38 of the local system 20. In step 154, a determination is made as to whether the event is a file access request. If a negative determination is made, step 152 is re-invoked, so that additional events can be monitored for and processed in accordance with the present invention.

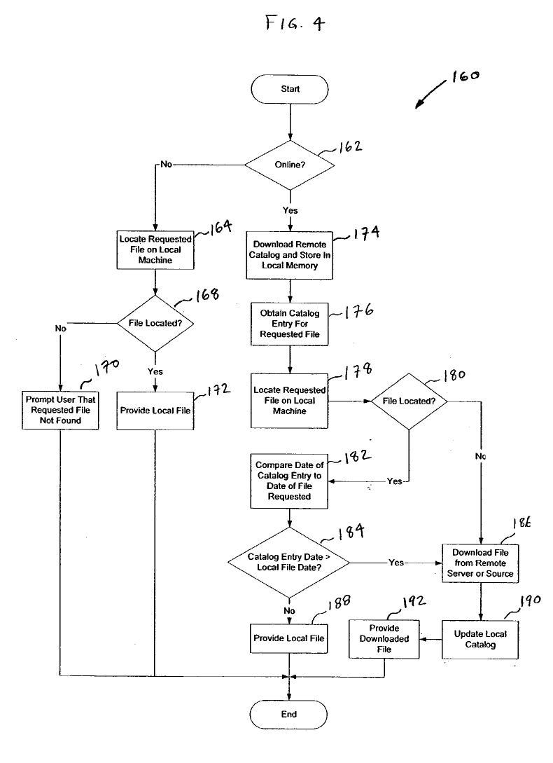

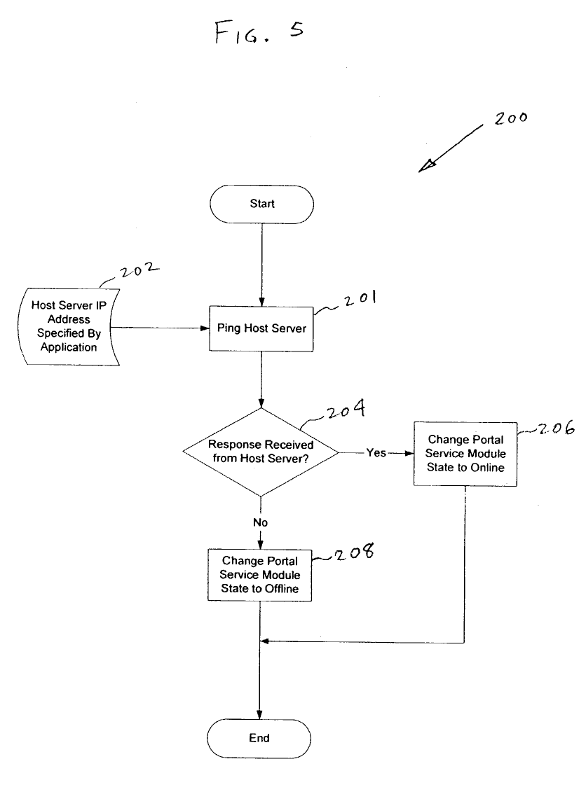

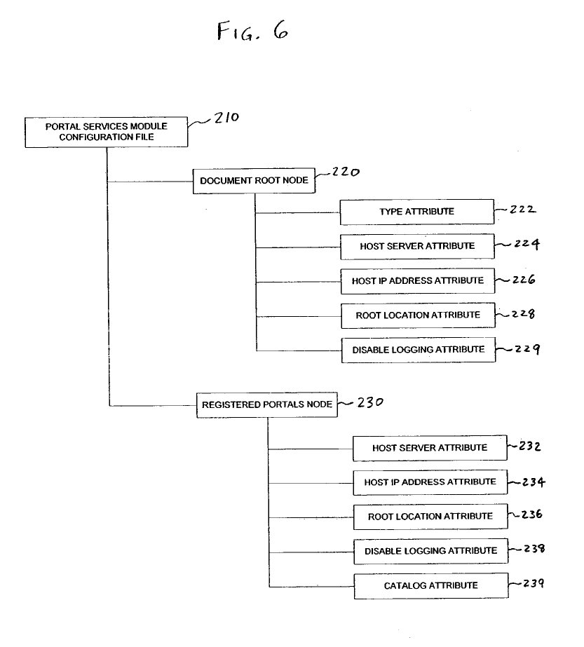

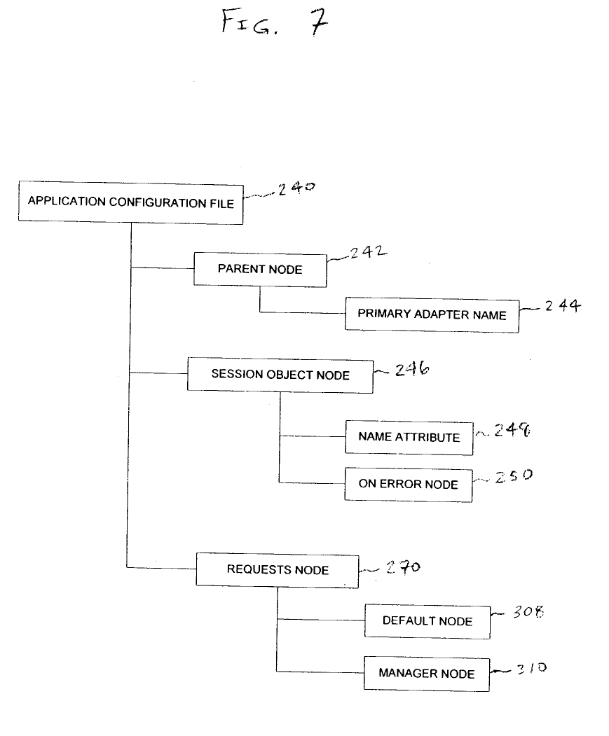

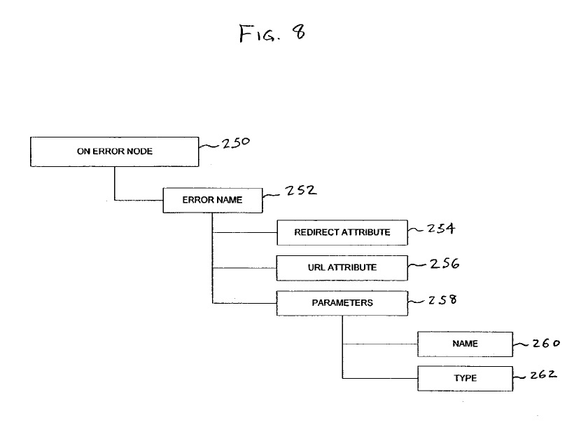

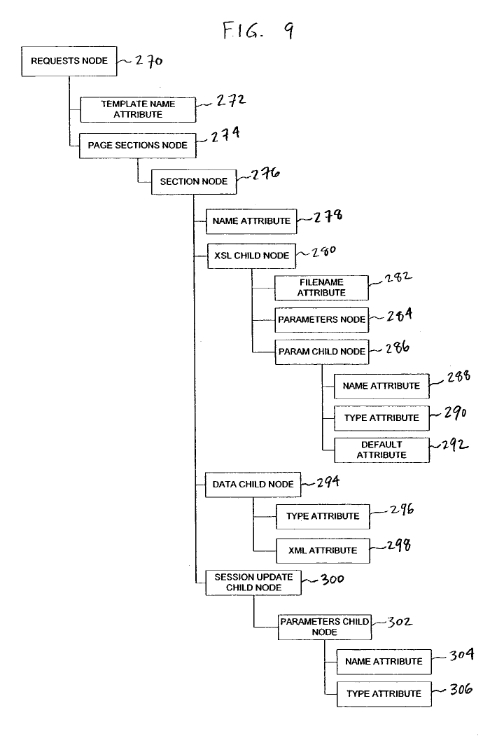

In the event that a positive determination is made in step 154, step 156 is invoked, wherein the file access request is passed to a request handling module. This module, as will be discussed in greater detail below with reference to FIG. 4, determines whether the user is online or offline, updates local content if the user if online, searches for the requested file, and, if available, provides the requested file. Then, in step 158, the requested file is opened by the portal services module 32, processed, formatted for presentation within the portal environment, and presented to the user within the portal page 40 of the web browser 38. After the file has been opened, processed, and displayed, step 158 re-invokes step 152, so that additional events can be processed in accordance with the present invention.

FIG. 4 is a flowchart showing processing logic, indicated generally at 160, for providing content in response to user requests and automatically updating local content from one or more remote servers. The process 160 preferably forms part of the portal services module 32, discussed earlier, and is initiated in the event that a file access request has been determined to occur in step 156 of FIG. 3. Beginning in step 162, a determination is made as to whether the user is online or offline. If the user is offline, step 164 is invoked, wherein an attempt is made to locate the requested file on the local system. In step 168, a determination is made as to whether the requested file exists on the local system. If a negative determination is made, step 170 is invoked, wherein a message is created indicating that the requested file is not found locally and requires network connectivity to be retrieved. If a positive determination is made, step 172 is invoked, wherein the requested file is provided from the local system.

In the event that a negative determination is made in step 162 (the user is online), step 174 is invoked. In step 174, the remote system is contacted via an HTTP request, and the remote portal catalog is downloaded and stored in local memory. Then, in step 176, the downloaded remote portal catalog is queried for an entry corresponding to the requested file. In step 178, an attempt is made to locate the requested file on the local machine. A determination is then made in step 180 as to whether the requested file is located. If a positive determination is made, step 182 is invoked, wherein the date of the catalog entry corresponding to the requested local file is compared to the date of the local file. Step 184 is then invoked, wherein a determination is made as to whether the catalog entry date is greater than the local file date. If a negative determination is made, step 188 is invoked, wherein the local file is provided. In this case, the local file is determined to be the most current version, and is provided to the portal services module for processing.

In the event that a negative determination is made in step 180 (the requested file is not located on the local machine), or in the event that a positive determination is made in step 184 (the catalog entry date is not greater than the local file date), the requested file either does not exist on the local machine, or if it does, a more current version exists on the remote system. In either case, step 186 is invoked, wherein the requested file is downloaded from the remote system (or other source). Then, step 190 is invoked, wherein the local catalog is updated to indicate that the most current version of the requested file has been downloaded locally, and the date of the download is recorded. In step 192, the downloaded file is provided to the portal services module of the present invention for processing.

FIG. 5 is a flowchart showing processing logic, indicated generally at 200, for determining whether a user is online or offline and for updating portal state information. As mentioned earlier, the portal services module of the present invention dynamically updates local content when the user is online. In order to achieve this result, it is necessary to determine whether the user is online or offline. Beginning in step 201, a target host server is queried for a response, using the “ping” utility available with the Transmission Control Protocol/Internet Protocol (TCP/IP) protocol suite. The identity of the target host server is stored in pre-defined variable 202 as an IP address that is specified by an application or configuration file. In step 204, a response to the ping query is monitored for. If a response is not received, step 208 is invoked, and the user is determined to be offline. A variable within a portal configuration file is set to reflect offline status, thereby changing the state of the portal service module to “offline.” If a response is received from the host server, step 206 is invoked, wherein the user is determined to be online. The variable within the portal configuration file is set to reflect online status, thereby changing the state of the portal service module to “online.” Of course, any other method of ascertaining the status of the remote host (other than the “ping” method) could be employed without departing from the spirit or scope of the present invention.

When the online or offline status of the user is determined, and appropriate variable are set, an indication within the portal environment of the present invention is made corresponding to such status. For example, such indication could be an icon within a portal page, indicating that the user is online. Any other indication could be provided.

In a preferred embodiment of the present invention, the online/offline detection process 200 is initiated whenever a user utilizing the portal environment requests a file. However, such process could be executed as desired, and need not be executed with each file request. For example, a daemon or other process executing on the local system could be scheduled to initiate process 200 at pre-determined times, so as to occasionally ascertain online/offline status and to update the state of the portal services module of the present invention.

In response to requests for content initiated by the user within the portal environment of the present invention, the portal services module identifies and retrieves the content in the manner disclosed herein, and dynamically updates content for online and offline usage. In addition to the processing logic discussed above, the present invention utilizes a plurality of configuration files for formatting and presenting local and remote content to the user in the portal environment. Such files are preferably XML document templates, XSL stylesheets, and HTML files, but could be any file type known in the art. The configuration files will now be discussed with reference to FIGS. 6-11.

FIG. 6 is a diagram showing a preferred file structure for the portal service module configuration files of the present invention, indicated generally at 210. The configuration file 210 is preferably an XML file, and is accessed by the portal services module 32 of the present invention. Of course, any other known file structure or format could be utilized without departing from the present invention. This file preferably comprises a tree structure, and has both root (parent) and child nodes. The two primary child nodes are the document root node 220 and the registered portals node 230.

The document root node 220 identifies the configuration file 210 as a portal services configuration file, and comprises a plurality of attribute nodes 222-229. The type attribute node 222 identifies the mode in which the portal services module is currently running, and can be set to either “Local” or “Server.” If set to “Local,” the portal services module of the present invention is assumed to be running on a mobile (e.g., laptop) system, and the portal catalog services, discussed earlier, will be performed. Otherwise, if the node 222 is set to “Server,” the portal services module is assumed to be running on a server (e.g., a remote system), and cataloging services need not be performed.

Host server attribute node 224 identifies the location of the content identified by the either the local or remote portal catalogs of the present invention. In server mode, node 224 is not utilized. The host IP address attribute node 226 contains the IP address of the host server, and is utilized in determining whether the use is online or offline. In server mode, node 226 is not utilized. The root location attribute node 228 identifies the location of all files on the machine that are utilized by the portal services module of the present invention. Disable logging attribute node 229 controls logging of requests by the portal services module. If set to boolean “True,” the portal service module will not log any requests. Otherwise, all requests will be logged.

The registered portals node 230 identifies each portal created by the present invention within the portal environment. Attributes of this node are considered ‘global,’ and files identified within the node 230 can be used by any application. Further, a plurality of portal nodes 230 corresponding to a plurality of portals can be provided, each identified by an application name and each having its own attribute nodes. The host server attribute node 232 identifies the location of all content for a given application. This attribute is not used when the portal services module is operating in server mode. The host IP address attribute node 234 contains the IP address of the application's host server. The root location attribute node 236 identifies the location of all files on the local machine for the application. The disable logging attribute node 238 controls logging of requests by the portal services module, and can be set to boolean “True” or “False.” The catalog attribute node 239 identifies the name of the catalog for the application. When the user is online and a file request has been received, the portal service module of the present invention attempts to download the catalog identified by node 239 from the application's host server.

FIG. 7 is a diagram showing a preferred file structure for the application configuration files of the present invention, indicated generally at 240. The configuration file 240 is preferably an XML file, and is accessed by the portal services module 32 of the present invention. Of course, any other known file structure or format could be utilized without departing from the present invention. This file preferably comprises a tree structure, and has both root (parent) and child nodes. The three primary child nodes are the parent node 242, session object node 246, and the requests node 270.

The parent node 242 stores the name of the application, and has a primary adapter node 244. The primary adapter name node 244 is responsible for receiving and responding to messages that are sent to the node by the portal services module of the present invention. In this node, an application adapter name for the application can be specified. Such an adapter can be provided by the PDX system referred to earlier, or by any other application integration service. This node is optional.

The session object node 246 stores session state information pertinent to the user's current session within the portal environment of the present invention. This node is optional, and need not be provided if session state information is not required. The object node 246 implements a specified interface to achieve functionality. A plurality of variables can be defined for this node, including, but not limited to, variables for the name of the interface, as well as the names of functions for starting the session and updating session information. When a request is made to one or more session objects, the object performs the necessary work, and an XML document is returned. The values of the XML document are then used to update application-level and session-level cookies. In a preferred embodiment of the present invention, the session objects are Component Object Model (COM) objects, and each can assume different roles for different users. If no role is specified for the object, a default value is assumed. The name of the session object node 246 can be set to the name of the user role for the session object, or to a default value for non-role-specific session objects. Further, multiple session object nodes 246 can be provided where multiple roles exist. The session object node 246 contains two child nodes, namely name attribute node 248 and on error node 250.

When used, session objects allow the present invention to create and maintain session-level cookies for applications. By implementing interfaces for the component objects, the present invention has the capability of executing standard methods against the component objects. The portal services module can initiate a start method on the object when the session first initiates. The logic within the start method can including any logic required by the application. No specific logic is required. However, the return value of the start method must be an XML document in a specified format. Session objects also allow session updates, wherein a standard method is called against the session object, passing in a request name string variable. The request name informs the session object of a session update to take place. A parameters value is passed to the session object, as well, and includes a collection of name/value pairs that are used by the session object while performing a session update.

The name attribute node 248 contains the name of the session object and class, in an “Object.ClassName” format. This value can be used by the portal services module of the present invention to instantiate the object and to execute methods on the object. The on error node 250, as will be described in greater detail, identifies a plurality of attributes that are utilized in the event of an unsuccessful session startup.

The requests node 270 contains information regarding each request for an application generated during a session within the portal. The requests can be made at a user role level. In cases where there are no role-specific requests, a default section can be provided. Where multiple roles exist, multiple request definitions (hence, multiple request nodes 270) can be provided, each having the same name or different names. Thus, as shown in FIG. 7, a default node 308 and a “manager” node 310 are provided by way of illustration, wherein the default node 308 handles non-role-specific quests and the “manager” node 310 handles requests specific to a manager's role. Of course, any number of roles and nodes can be provided and expanded as desired.

FIG. 8 is a diagram showing, in greater detail, the structure of on error node 250 of FIG. 7. The on error node 250, as discussed earlier, handles errors that may occur during an unsuccessful session startup. If an error occurs, the on error node 250 returns an error code. In a preferred embodiment of the present invention, the error code is compatible with the PDX system, and can be handled thereby. This node is optional, and if not provided, a standard error message is displayed. The on error node 250 can be named according to the error code detected, and the name stored in error name node 252.

The redirect attribute node 254 and URL attribute node 256 store values corresponding, respectively, to a new error message indication and a URL to which the user is directed in the case of an error. The parameters attribute node 258 is an optional node that can contain additional parameters to be appended to the URL stored in the URL attribute node 256. Each parameter to be appended is identified by child nodes 260 and 262. Name node 260 contains the name of the parameter to be appended to the URL. Type node 262 specifies the type of parameter, or alternatively, the location of a stored value. Two possible values are session information and cookie information. If the type is set to session information, the value is obtained from a returned session information XML document. If the type is set to cookie, the value is obtained from the application's cookie values. Once the value has been obtained, the URL is appended with the name and type attributes.

FIG. 9 is a diagram showing, in greater detail, the structure of requests node 270 of FIG. 7. As mentioned previously, the requests node 270 stores information pertinent to a request made in the portal environment for an application. Multiple requests nodes 270 can be provided for multiple application requests. Requests can be made having user role levels, or alternatively, with no roles. All requests are XML nodes, with the name of the node being set to the name of the application request. Template name attribute node 272 specifies the name of the HTML template (file) to use for a given request. If the name of the template begins with an “@,” the portal services module of the present invention will look for this file in a directory on the local machine (the “PortalServices\Templates” directory). If an “@” indication is not present, the portal services module will retrieve the template file from a template sub-directory found under the application's root directory.

The page sections node 274 defines data and styles to be used to build a page within the portal environment of the present invention. Multiple section nodes 276 can be defined, corresponding to multiple page sections. Each section node 276 is named according to the name of each section, and subsections are allowed within each section. For example, a “TOP” section could be defined, as well as a “BOTTOM” section. The name of each section is stored in the name attribute node 278. The name stored therein corresponds to a tag in an HTML template. For example, HTML tags “TOP:SUB1” and “TOP:SUB2” could exist, and the names “SUB1” and “SUB2” stored in the name attribute node 278, as well as the name “TOP” stored in the sections node 276.

XSL child node 280 defines the stylesheet to be used to build the corresponding section of the page. The filename attribute 282 specifies the name of an XSL stylesheet (file) to be used for a specific area of the section. If the name of the XSL file begins with an “@,” the portal services module of the present invention searches for the file within a predetermined directory (the “PortalServices\XSL” directory). If no “1” sign precedes the filename, the portal services module retrieves the file from the XSL sub-directory found in the application's root directory. The parameters node 284 allows XSL parameters to be passed to the XSL stylesheet. Each parameter is defined by creating a child node named “PARAMM” under the parameters node 284 for each desired parameter. For example, a PARAM child node 286 could be provided, having a name attribute node 288 (the name of the parameter), a type attribute node 290 (location where portal services module will retrieve the parameter value (e.g., Form, Cookie, Querystring, or Constant)), and a default attribute node 292 (default value if no value can be located).

In conjunction with the styles defined by XSL child node 280, data child node 294 defines the data to be used with the styles. Type attribute node 296 specifies the type of data to be used. Examples include XML data (data stored in XML format), or PDX data (data stored in a format compatible with the aforementioned PDX system). If the attribute is set to XML, the portal services module of the present invention will use a local XML file. If the attribute is set to PDX, the portal services module will formulate a PDX message and will execute same using the PDX system. Thus, using the PDX system, or any other similar application integration service, the portal services module of the present invention allows multiple applications from multiple vendors to be linked with the portal environment. The configuration files for such an application integration service will be discussed later in greater detail.

The XML attribute node 298 specifies the name of the XML file, if an XML file is to be used as a data source. If the name of the file begins with an “@,” the portal services module of the present invention will retrieve this file from a pre-defined directory on the local machine (the “PortalServices\XML” directory). If no “@” symbol precedes the filename, the portal services module will retrieve the file from the XML sub-directory found under the application's root directory. This attribute is used only where the type attribute node 296 is set to XML.

The session update child node 300 allows for session state information to be updated after a request has been processed by the present invention and completed. This can be achieved by updating session-level cookies. When a session update node is defined, the portal service module will call the “execute” method of the session object, passing in the value of this attribute as a parameter. This allows the session object to ascertain the session update to take place. This information can be stored in a parameters child node 302. The name attribute node 304 of the parameters child node 302 defines the name of the parameter to place into the message for the session object (e.g., a PDX message), and is used to obtain the parameter value from the source. The type attribute node 306 of the parameters child node 302 specifies a location for the parameter value. Exemplary locations could be a form, querystring, cookie, or constant. If the type is set to “form,” the portal services module will retrieve the value from the incoming request form within the portal environment, using the name attribute as the name of the form field. If the type is set to “querystring,” the portal services module will retrieve the value from the incoming request query string, using the name attribute as the name of the querystring parameter. If the type is set to “cookie,” the portals services module will retrieve the value from the application's cookie, using the name attribute as the name of the cookie field. If the name attribute is preceded by an “@” symbol, the portal services module will retrieve the value from a portal services module-level cookie. If the value is set to “constant,” then a fixed value will be passed with the request. Such value could be stored in a default attribute node.

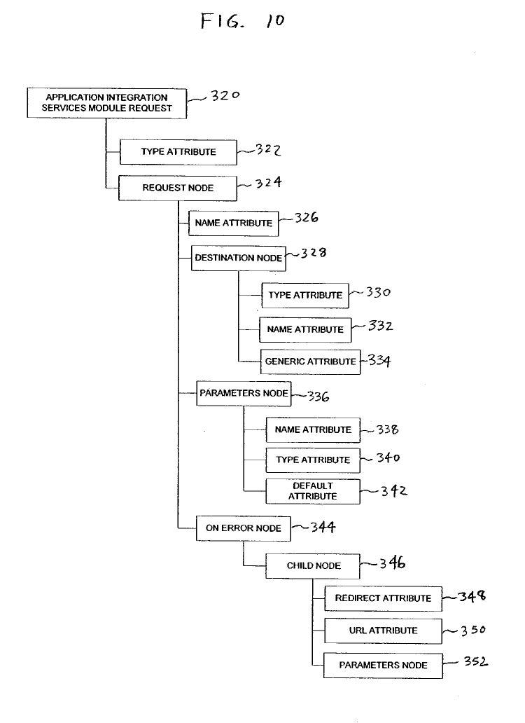

FIG. 10 is a diagram showing a preferred file structure, indicated generally at 320, for handling requests to the application integration services module of the present invention. As mentioned earlier, the present invention is operable with any known application integration service, such as the PDX system, that allows multiple applications from multiple vendors to be used interchangeably. In a preferred embodiment of the present invention, requests are dispatched between such an application integration services system and the portal services module of the present invention, using an application integration service module request file 320. This file is preferably an XML file, but could be any type of file.

The type attribute node 322 of the request file 320 indicates the type of application integration service system to which the request is dispatched. For example, if the request is for a PDX system, the type attribute is set to “PDX.” The request node 320 contains all information pertinent to the request, including information to be executed by the application integration system. The name attribute node 326 contains the name of the application integration service request to execute (e.g., the name of a PDX request). The destination node 328 defines which application adaptor to use for receiving and processing the request. The type attribute 330 contains the location to be utilized by the portal services module for retrieving the name of the application adaptor. Possible values include “querystring” (value to be retrieved from a query string), “cookie” (value to be retrieved form a cookie), or “constant” (value to be retrieved from a pre-determined constant). The name attribute node 332 stores the name of the query string from which to retrieve the value, and is utilized only if the type attribute node 330 is set to “querystring.” The generic attribute node 334 can be set to boolean “true” or “false.” If “true,” the request message will be sent directly to the adapter without any user-specific information. If “false,” the portal services module will obtain information from the user, include the information in the request message, and will send the request message to the application adapter.

The parameters node 336 defines parameter values that will be used when constructing the request message. The name attribute node 338 defines the name of the parameter to place into the request message. The name is also used to obtain the parameter value from a source. Type attribute node 340 specifies a location from which the value is to be obtained. If the type is set to “form,” the portal services module retrieves the value from an incoming request form, using the name attribute as the name of the form field. If the type is set to “querystring,” the portal services module retrieves the value from an incoming query string, using the name attribute as the name of the query string parameter. If the type is set to “cookie,” the portal services module retrieves the value from the application's cookie, using the name attribute as the name of the cookie field. If the name attribute is preceded by an “@” symbol, the portal services module will retrieve the value from a portal services-level cookie. If the type is set to “constant,” a fixed value is provided and passed to the application integration service via the request message. A default attribute node 342 defines a default value for the parameter if the type is “constant,” or if the portal services module cannot locate the required field in the form, query string, or cookie.

The on error node 344, handles errors that may occur during an unsuccessful application integration process (or, PDX process). In the case of PDX errors, a PDX error message is generated, using a simple naming convention (e.g., a “PDX” prefix, followed by an error code integer, such as “PDX1023” or “PDX1498”). This node is optional, and if not provided, a standard error message is displayed. The name stored is stored in child node 252, and a plurality of child nodes 252 can be provided for reporting a variety of errors.

The redirect attribute node 348 and URL attribute node 350 store values corresponding, respectively, to a new error message indication and a URL to which the user is directed in the case of an error. The parameters attribute node 352 defines additional parameters to be appended to the query string of the URL stored in the URL attribute node 350. Each parameter to be appended is identified by child nodes. A name node contains the name of the parameter to be appended to the URL. A type node specifies the type of parameter, or alternatively, the location of a stored value. Two possible values, among others, are session information and cookie information. If the type is set to session information, the value is obtained from a returned session information XML document. If the type is set to cookie, the value is obtained from the application's cookie values. Once the value has been obtained, the URL is appended with the name and type attributes.

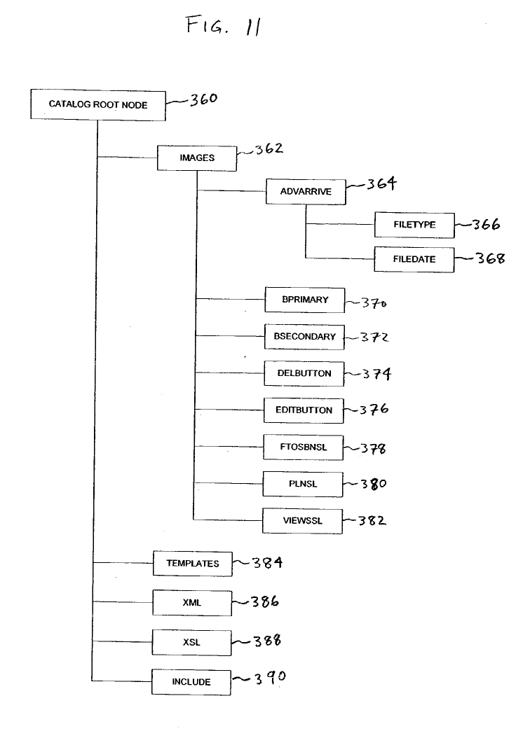

FIG. 11 is a diagram showing a preferred file structure, indicated generally at 360, for allowing automatic updating of local content. The structure 360 operates as a portal catalog, and can be used both locally and remotely. The catalog 360 comprises four main child nodes: images node 362, templates node 384, XML node 386, XSL node 388, and include node 390. Importantly, the catalog 360 allows a user to download files and save same locally when the user is online, thus allowing access to updated content when the user is offline. As the user navigates through the portal environment of the present invention, requests are made to the portal services module. Responses are built based upon information that is pertinent to the request and located in the configuration files of the present invention. The catalog 360 is preferably an XML file.

The images node 362 stores images and other types of data for display in the portal. A plurality of child nodes could be provided, each corresponding to objects within the portal. For example, an ADVARRIVE node 364, having a file type node 366 and a file date node 368, could be provided for storing updated content and reflecting when the updated content was last downloaded to the local machine. Other nodes corresponding to objects within the portal, such as BPRIMARY node 370 (primary button), BSECONDARY node 372 (secondary button), DELBUTTON node 374 (delete button), EDITBUTTON node 376 (edit button), and miscellaneous nodes 378, 380, and 382, could be provided and stored within the images node 362. Of course, any desired number and combination of child nodes could be provided.

The templates node 384 stores information relating to the location and identity of template files to be used by the portal services module of the present invention in constructing and operating components within the portal environment. The XML node 386 and XSL node 388 store, respectively, information relating to the identity and location of XML and XSL files for use in the portal. The include node 390 likewise stores information relating to the identity and location of configuration files that are used with the portal environment. When a request for information occurs, the file date of files indicated by each of these nodes are compared to the file dates indicated in the remote portal catalog downloaded to the local machine. If the local file dates are older than the remote file dates, some (or all) of the files indicated in the catalog 360 are selectively downloaded to the local machine, and the catalog 360 is updated to reflect the date of the download(s). In this manner, content on the local machine is dynamically updated so that the next time the user is offline, the most recent (updated) version of content is made available to the user.

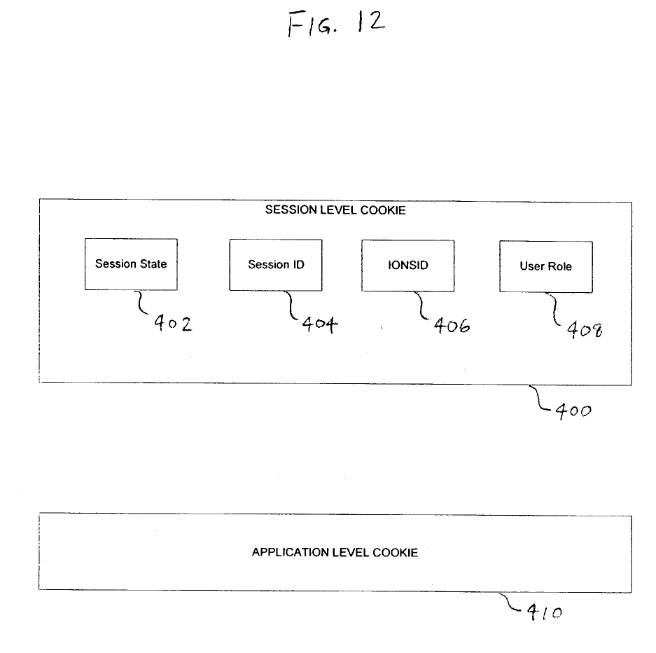

FIG. 12 is a block diagram showing session-level and application-level cookies utilized by the present invention. A session-level cookie 400 can be provided for each type of session state information desired to be monitored and/or controlled. The cookie could contain a session state field 402, a session identifier (ID) field 404, an IONSID field 406, and a user role field 408. The session state field 402 could reflect online/offline status. The session ID field 404 could store a unique group/user ID. The IONSID field 406 can be utilized for storing login information for a remote server. This field could be formatted for use with a WINDOWS NT logon, an IIS logon, or any other type of system login procedure. User role field 408 could store information about a user's role. The session-level cookie 400 could be assigned by any application. Additionally, an application-level cookie 410 can be provided for monitoring and/or controlling application behavior.

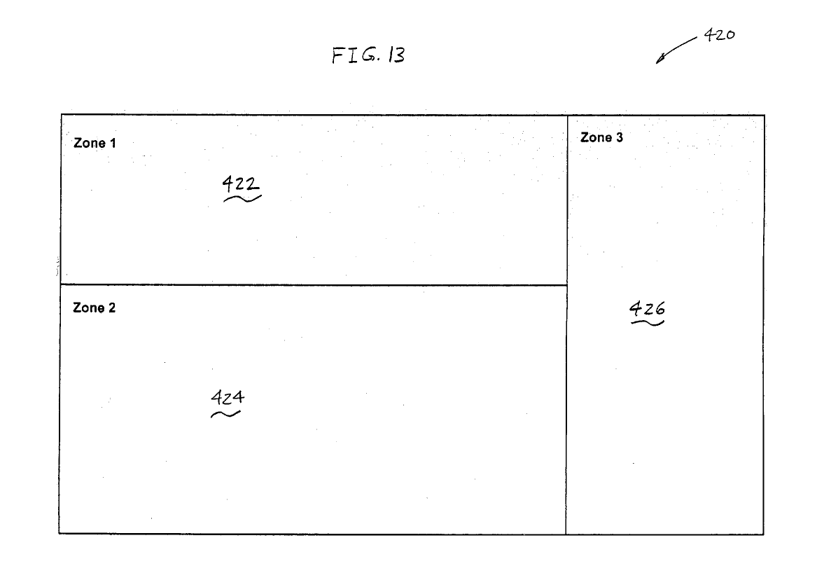

FIG. 13 is a diagram showing a sample portal layout. A portal page 420 (similar to the portal page 40 of FIG. 1) provides a central location having a unified look-and-feel, wherein the user can access both remote and local applications and data. A plurality of zones, such as zones 422, 424, and 426, can be provided for organizing the presentation of information within the portal. The page 420, in addition to the zones 422-426, are each controlled by the portal services module of the present invention. Any desired number of zones in any spatial configuration can be provided.

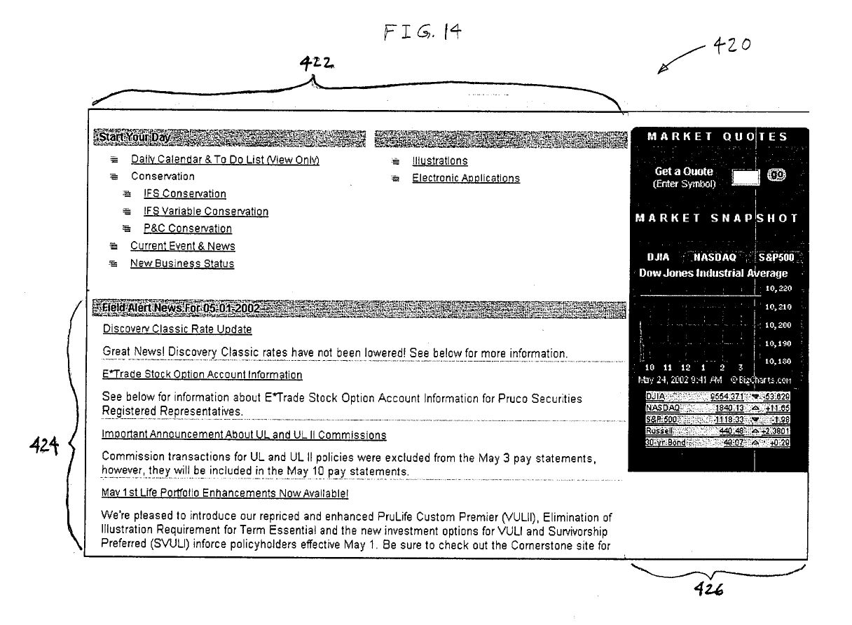

FIG. 14 is a diagram showing the sample portal layout of FIG. 13, wherein both local and remote content and applications are accessible by the user. The first zone 422 provides access to local and remote applications. For example, the “IFS Conversion” hyperlink provides access to a proprietary software package that could execute either locally or remotely. Links to other applications could also be provided, and the applications integrated using PDX or other similar package. In zone 424, content stored locally and updated when the user is online is displayed. In zone 426, content from an online provider, such as DOW JONES, is displayed to the user. Importantly, all of the content displayed in the page 420, and within its zones, can be accessed by the user when he or she is both online and offline. If a user clicks on a link to a remote application and the user is offline, the system responds and prompts the user to connect to a network. If the user clicks on a link to content that does not require connectivity and the user is offline, the most recently downloaded content is displayed to the user. When the user next goes online, the local content store is dynamically updated in accordance with the present invention.

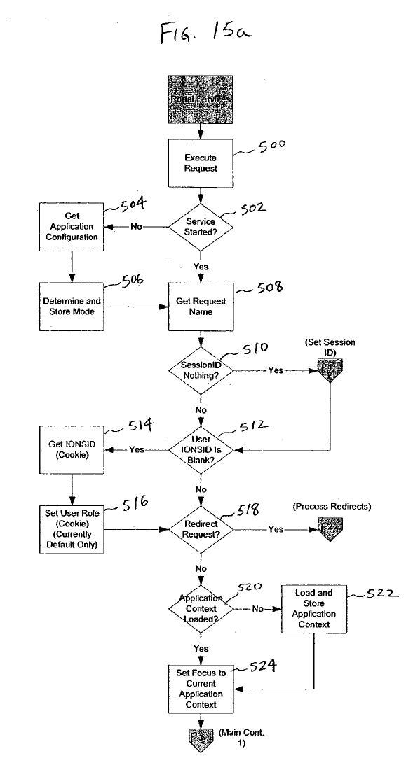

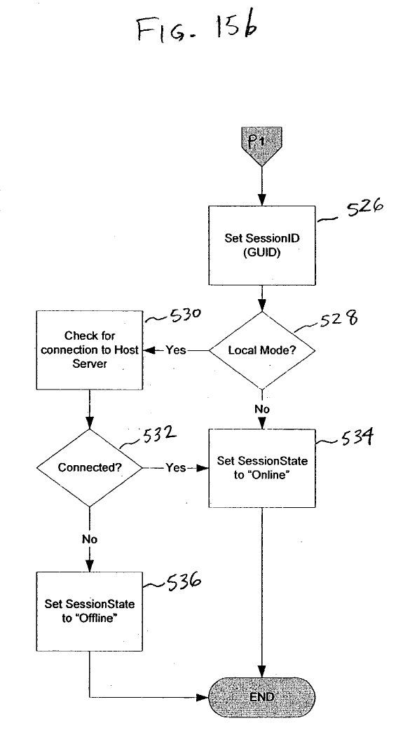

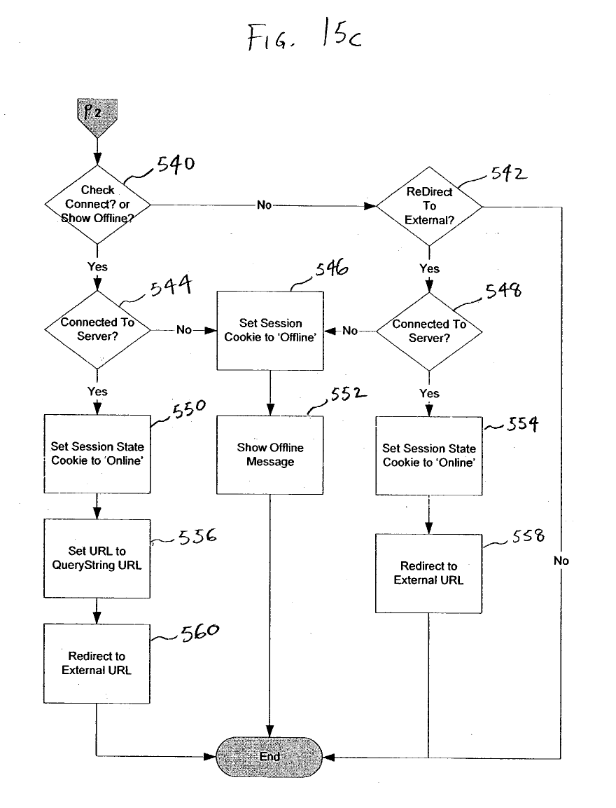

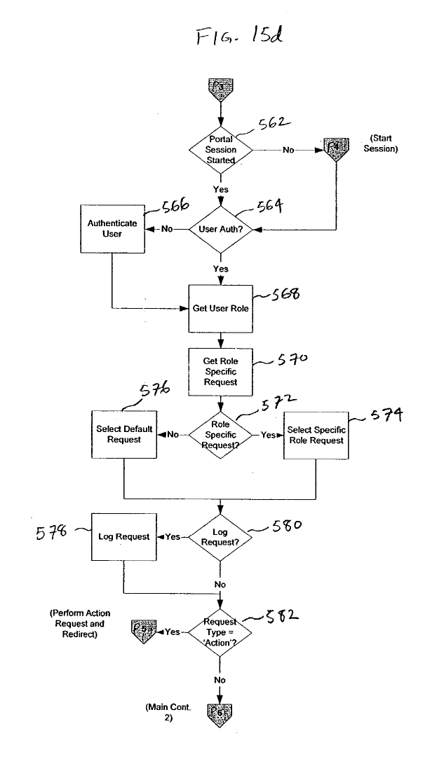

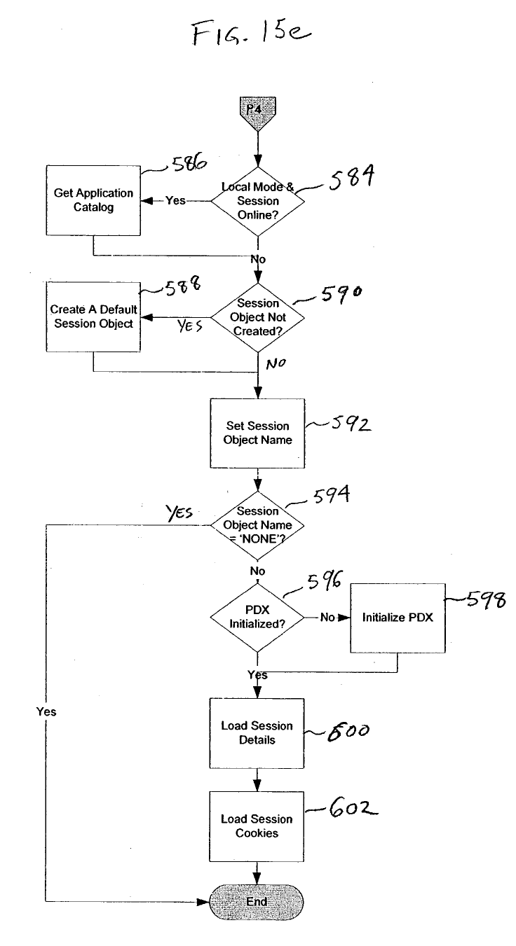

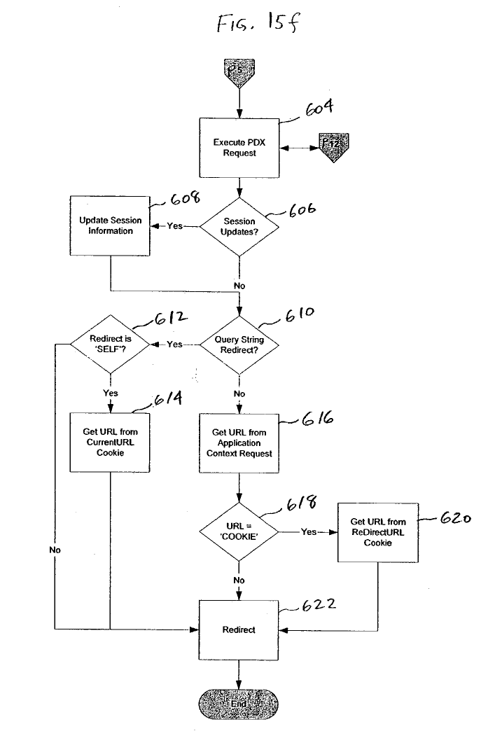

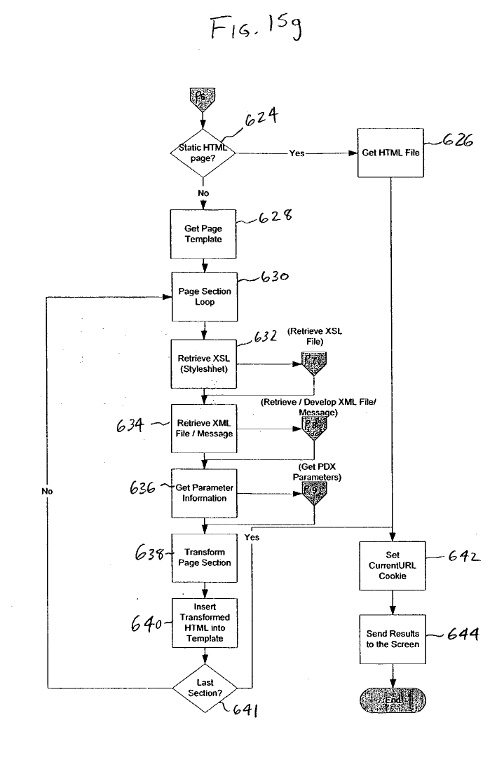

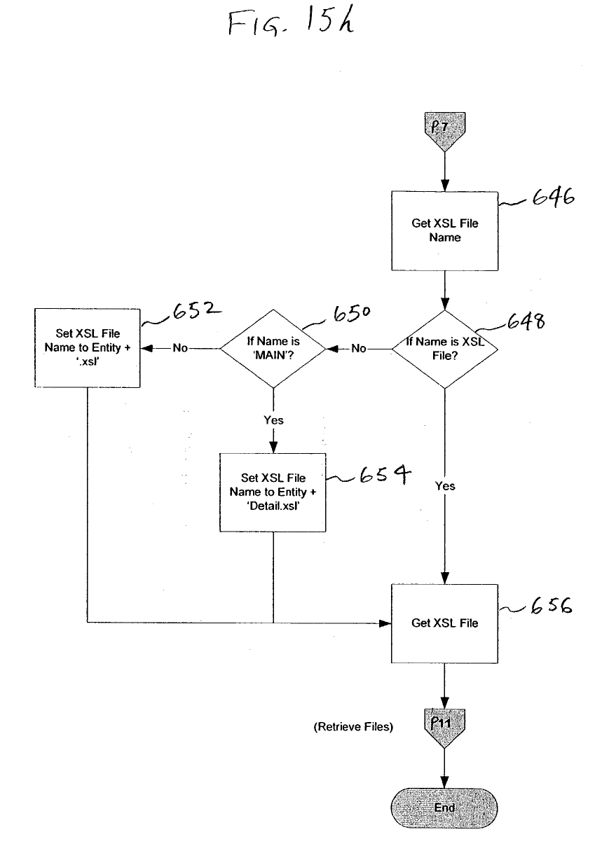

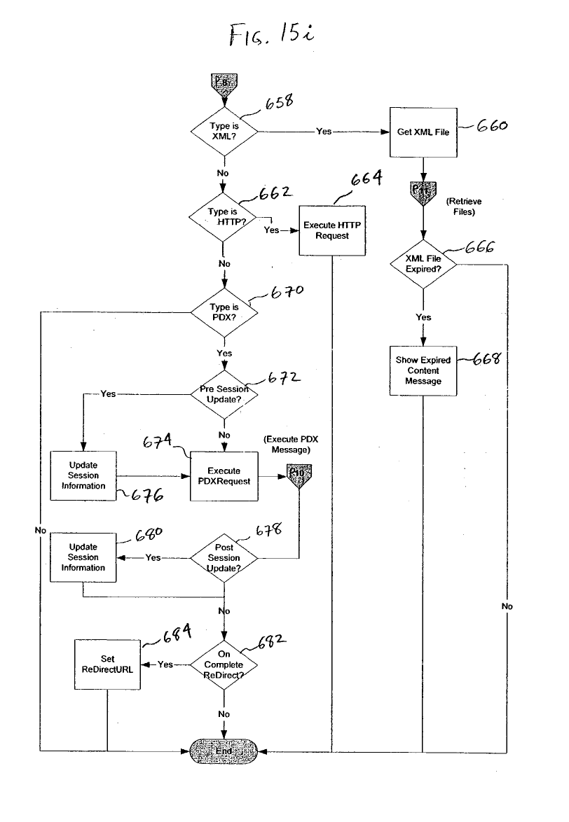

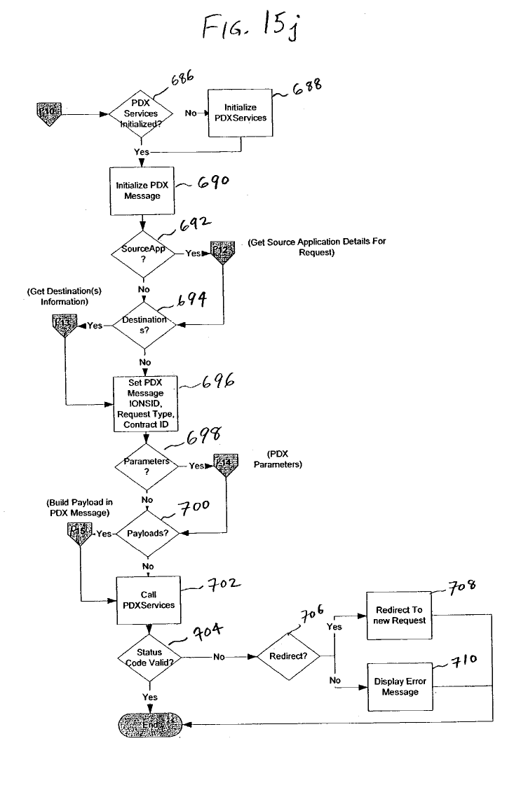

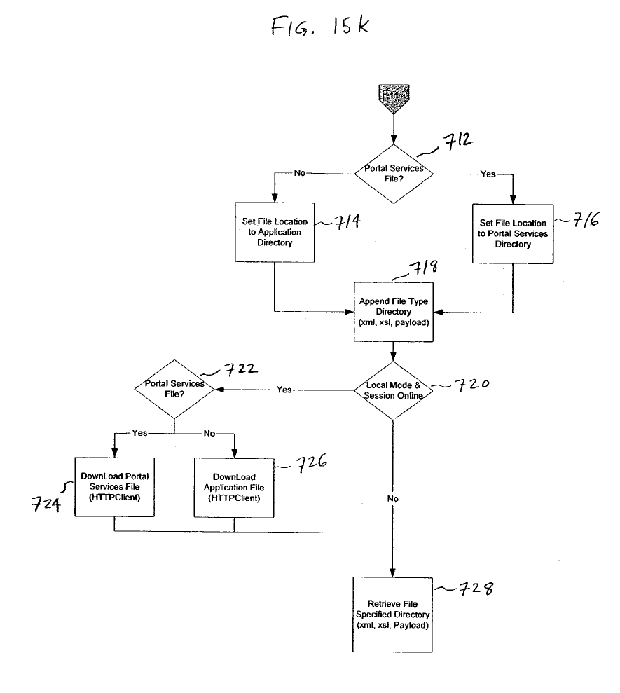

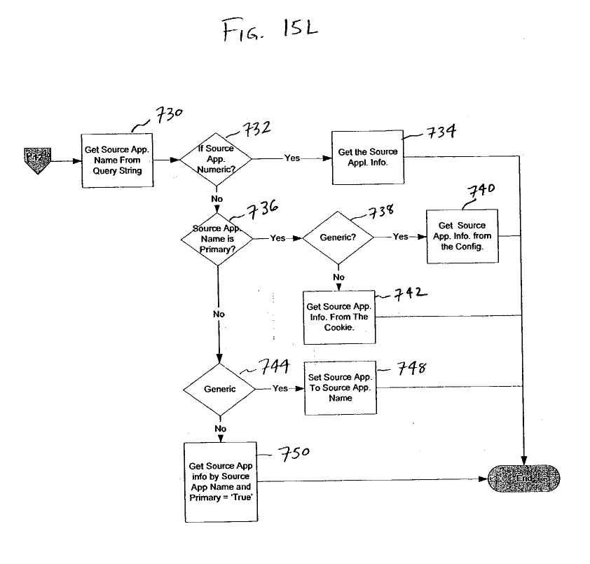

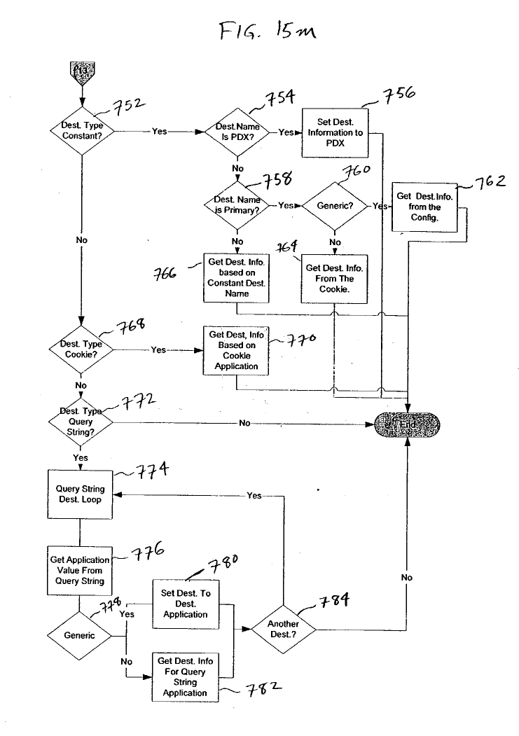

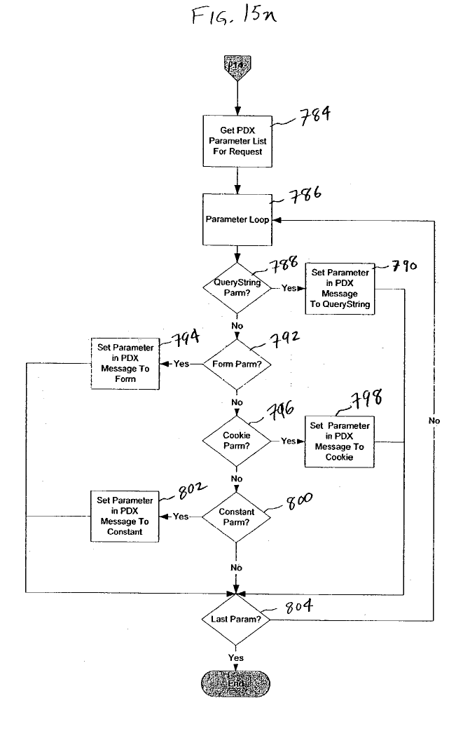

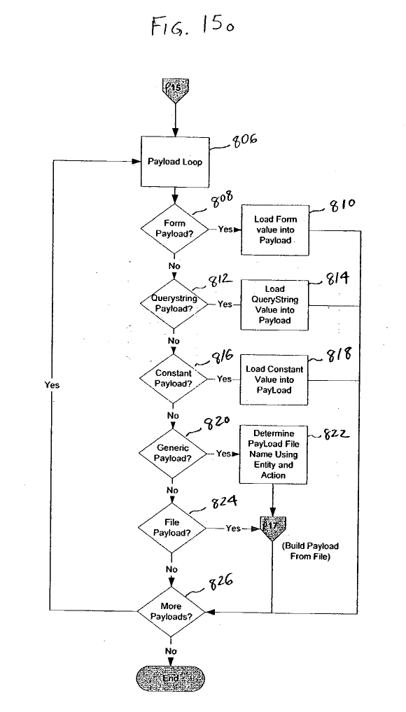

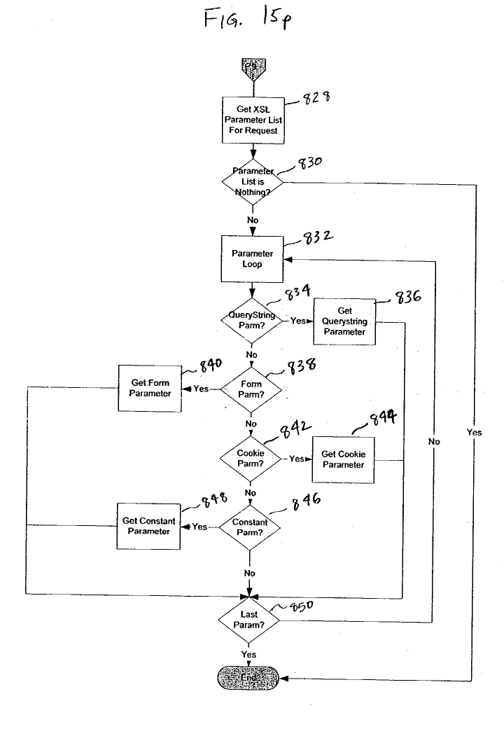

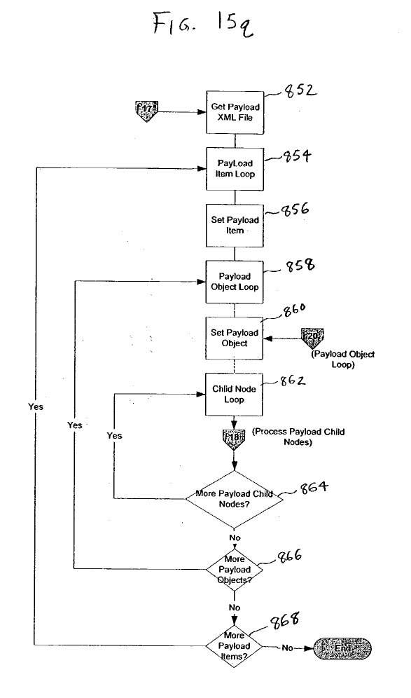

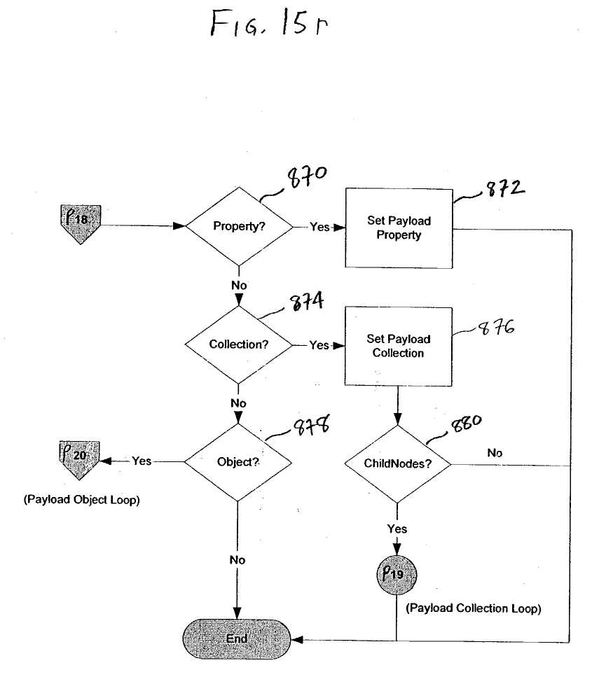

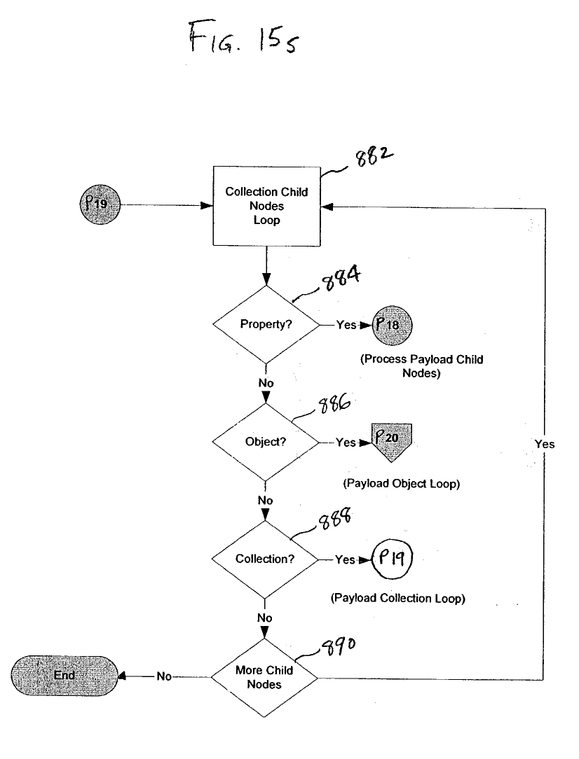

FIGS. 15a-15s are flowcharts showing processing logic of the present invention. Such logic preferably is embodied in an application that executes on a remote computer system, such as a remote user's laptop or PC. Further, the logic disclosed herein can be embodied in any computer program(s) coded in any language known in the art, and executed on any suitable computer system.

FIG. 15a is a flowchart showing processing logic of the present invention. Beginning in step 500, a request is received from the portal environment and executed. In step 502, a determination is made as to whether a service corresponding to the request has been started. If positive determination is made, step 508 is invoked, wherein the request name is retrieved. If a negative determination is made, step 504 is invoked, wherein application configuration information is retrieved. Then, step 506 is invoked, wherein the mode of the application is determined and stored. Step 508, described earlier, is then invoked.

Step 508 invokes step 510, wherein a determination is made as to whether the session ID value corresponding to the current session is set to nothing. If a positive determination is made, process P1, described later, is invoked. Otherwise, step 512 is invoked, wherein a determination is made as to whether the aforementioned IONSID field is blank. If so, step 514 is invoked, wherein the IONSID value is retrieved from a cookie. Step 516 is then invoked, wherein the user role is set according to the cookie. Step 518 is invoked by step 516, or by step 512 in the event that a negative determination is made, wherein a determination is made as to whether the request is redirect request. If a positive determination is made, process P2, described later, is invoked. Otherwise, step 520 is invoked, wherein a determination is made as to whether an application context is currently loaded. If a positive determination is made, step 524 is invoked, where the focus of the portal environment is set to the current application context. If a negative determination is made, step 522 is invoked, wherein an application context is loaded and stored. Then, step 524, described earlier, is invoked. Processing then continues to process P3, described later.

FIG. 15b is a flowchart showing additional processing logic of the present invention, indicated generally as process P1. Beginning in step 526, the session ID (or group user ID (“GUID”)) of the current session is set. Then, in step 528, a determination is made as to whether the portal environment is operating in a local mode. If a negative determination is made, step 534 is invoked, wherein the session state is set to online. Process P1 then terminates.

In the event that a positive determination is made by step 528, step 530 is invoked, wherein a check is made for a connection to a host server. In step 532, a determination is made as to whether such a connection is present. If so, step 534, discussed earlier, is invoked. Otherwise, step 536 is invoked, wherein the session state is set to offline. Process P1 then terminates.

FIG. 15c is a flowchart showing additional logic of the present invention, indicated generally as process P2. Beginning in step 540, a determination is made as to whether to check for a connection or show an offline condition. If a negative determination is made, step 542 is invoked, wherein a determination is made as to whether to redirect the user to an external connection. If a negative determination is made, process P2 terminates. If a positive determination is made, step 548 is invoked, wherein a determination is made as to whether to connect to a server. If a negative determination is made, step 554 is invoked, wherein the session state cookie is set to online. Step 558 is then invoked, and the user is redirected to an external URL. Process P2 then terminates.

In the event that a negative determination is made in step 548, step 546 is invoked, wherein the session state cookie is set to offline. Step 552 is invoked, wherein an offline message is displayed to the user. Process P2 then terminates. In the event that a positive determination is made by step 540, step 544 is invoked, wherein a determination is made as to whether to connect to a server. If a negative determination is made, step 546, discussed earlier, is invoked. Otherwise, step 550 is invoked, wherein the session state cookie is set to online. Step 550 then invokes step 556, wherein the URL is set to the value stored in the QueryString URL. In step 560, the user is then re-directed to the external URL. Process P2 then terminates.

FIG. 15d is a flowchart showing additional processing logic of the present invention, indicated generally as process P3. Beginning in step 562, a determination is made as to whether a portal session has been started. If a negative determination is made, process P4, discussed later, is invoked. Upon termination of process P4, or in the event that a positive determination is made by step 562, step 564 is invoked, wherein a determination is made as to whether the current user is authenticated. If a positive determination is made, step 568 is invoked, wherein the user's role is retrieved. Otherwise, step 566 is invoked, wherein the user is authenticated, and then step 568 is invoked.

In step 570, a request is retrieved. Step 572, a determination is made as to whether the request is a role-specific request. If a negative determination is made, step 576 is invoked, wherein a default request is selected. If a positive determination is made, step 574 is invoked, wherein a specific role request is selected. Then, step 580 is invoked, wherein a determination is made as to whether to log the request. If a negative determination is made, step 582 is invoked; otherwise, step 578 is invoked, wherein the request is logged, followed by step 582.

In step 582, a determination is made as to whether the request type is an action request. If a positive determination is made, process P5, discussed later, is invoked. Otherwise, process P6, also discussed later, is invoked.

FIG. 15e is a flowchart showing additional processing logic of the present invention, indicated generally by process P4. Beginning in step 584, a determination is made as to whether the portal environment is operating in local mode and a session is online. If a positive determination is made, step 586 is invoked, wherein an application catalog is retrieved. In the event that a negative determination is made by step 584, or after step 586 is complete, step 590 is invoked, wherein a second determination is made as to whether a session object has not been created. If a positive determination is made, step 592 is invoked, wherein the session object name is set. Otherwise, step 588 is invoked, wherein a default session object is created, followed by step 592.

In step 594, a determination is made as to whether the session object name is set to nothing. If a positive determination is made, process P4 terminates. Otherwise, step 596 is invoked, wherein a second determination is made as to whether an application integration service, such as PDX, is initialized. If a positive determination is made, step 600 is invoked, wherein session details are loaded. Otherwise, step 598 is invoked, wherein the application integration service, such as PDX, is initialized, followed by step 600. In step 602, session cookies are loaded, and process P4 terminates.

FIG. 15f is a flowchart showing additional processing logic of the present invention, indicated generally as process P5. Beginning in step 604, a request for an application integration service, such as PDX, is executed. Concurrently, process P12 is invoked. Then, step 606 is invoked, wherein a determination is made as to whether the session requires an update. If a positive determination is made, step 608 is invoked, wherein the session information is updated, followed by step 610. If a negative determination is made, step 610 is invoked, wherein a determination is made as to whether a query string exists indicating a redirect process. If a positive determination is made, step 612 is invoked, wherein a determination is made as to whether the redirect is set to “SELF.” If a negative determination is made, step 622 is invoked, wherein the redirect process is initiated. Otherwise, step 614 is invoked, wherein a URL is retrieved from a current URL cookie. Then, the aforementioned step 622 is invoked.

In the event that a negative determination is made by step 610, step 616 is invoked, wherein a URL is retrieved from an application context request. Then, step 618 is invoked, wherein a determination is made as to whether the URL is set to “COOKIE.” If a positive determination is made, step 620 is invoked, wherein a URL is retrieved from a re-direct URL cookie. Then, the aforementioned step 622 is invoked after step 620 terminates, or in the event that a negative determination is made in step 618. Process P5 then terminates.

FIG. 15g is a flowchart showing additional processing logic of the present invention, indicated generally as process P6. Beginning in step 624, a determination is made as to whether a static HTML page exists. If a positive determination is made, step 626 is invoked, wherein an HTML file corresponding to the page is retrieved. Step 642 is invoked, wherein the current URL cookie is set. Then, in step 644, the results are sent to the screen (e.g., to a portal page of the portal environment). Process P6 then terminates.

In the event that a negative determination is made by step 624, step 628 is invoked, wherein a page template is retrieved. Then, in step 630, a page section loop is initiated, followed by step 632, wherein an XSL stylesheet is retrieved. Process P7, discussed later, is also invoked. Then, in step 634, an XML file or message is retrieved, and process P8, discussed later is invoked. In step 636, parameter information is retrieved, followed by process P9, also discussed later.

In step 638, a page section transformation process is initiated, wherein one or more page sections are formatted and configured. Then, in step 640, the transformed HTML file is inserted into a page template. In step 641, a determination is made as to whether the last page section has been processed. If a negative determination is made, step 620 is invoked, so that additional page sections can be processed. If a positive determination is made, steps 642 and 644, discussed earlier, are re-invoked. Process P6 then terminates.

FIG. 15h is a flowchart showing additional processing logic of the present invention, indicated generally as process P7. Beginning in step 646, an XSL filename is retrieved. Then, in step 648, a determination is made as to whether the name corresponds to an XSL file. If a positive determination is made, step 656 is invoked, wherein the corresponding XSL file is retrieved. Then, process P11 is invoked, and process P7 terminates.

In the event that a negative determination is made by step 648, step 650 is invoked, wherein a determination is made as to whether the file name corresponds to “MAIN.” If a positive determination is made, step 654 is invoked, wherein the XSL filename is set to an entity plus “Detail.xsl.” Then, step 656 and process P11 are invoked. In the event that a negative determination is made by step 650, step 652 is invoked, wherein the XSL filename is set to an entity plus “.xsl.” The aforementioned steps 656 and process P11 are invoked, and process P7 terminates.

FIG. 15i is a flowchart showing additional processing logic of the present invention, indicated generally as process P8. Beginning in step 658, a determination is made as to whether the file or message is of an XML type. If a positive determination is made, step 660 and process P11 is invoked, wherein the XML file is retrieved. In step 666, a determination is made as to whether the retrieved XML file is expired. If a negative determination is made, process P8 terminates. Otherwise, step 668 is invoked, wherein a message is displayed to the user indicating that the content has expired. Then, process P8 terminates.

In the event that a negative determination is made in step 658, step 662 is invoked, wherein a determination is made as to whether the file or message type is HTTP. If a positive determination is made, step 664 invoked, wherein the HTTP request is executed, and process P8 terminates. Otherwise, step 670 is invoked, wherein a determination is made as to whether the file or message type is PDX (or, a type compatible with any application integration service). If a negative determination is made, process P8 terminates. Otherwise, step 672 is invoked, wherein a determination is made as to whether a pre-session update has occurred. If a positive determination is made, step 676 is invoked, wherein session information is updated. Step 674 and process P10 are then invoked by step 676, or by step 672 in the event that a negative determination is made thereby, and the PDX request is executed (or, a request for any application integration service is executed).

In step 678, a determination is made as to whether a post-session update has occurred. If a positive determination is made, step 680 is invoked, wherein session information is updated. Step 682 is then invoked by step 680, or by step 678 in the event that a negative determination is made thereby, and a determination is made as to whether a complete redirect process exists. If a positive determination is made, step 684 is invoked, wherein the redirect URL is set, and process P8 terminates. Further, if a negative determination is made by step 682, process P8 terminates.

FIG. 15j is a flowchart showing additional processing logic of the present invention, indicated generally as process P10. Beginning in step 686, a determination is made as to whether PDX services (or, services provided by an application integration service) are initialized. If a negative determination is made, step 688 is invoked, wherein PDX services (or, application integration services) are initialized. If a negative determination is made by step 686, or if step 688 terminates, step 690 is invoked, wherein a PDX message is initialized. In step 692, a determination is made as to whether the current application request is for a source application. If a positive determination is made, process P12 (discussed later) is invoked, followed by step 694. If a negative determination is made, step 692 invoked step 694.

In step 694, a determination is made as to whether a destination application request has been made. If a positive determination is made, process P13 (discussed later) is invoked, followed by step 696. Otherwise, step 694 invokes step 696. In step 696, a plurality of values are set, including the PDX message, the IONSID field, the request type, and a contract ID. In step 698, a determination is made as to whether any parameters exist. If a positive determination is made, process P14 (discussed later) is invoked, followed by step 700. Otherwise, step 698 invokes step 700. In step 700, a determination is made as to whether any payload data exists. If a positive determination is made, process P15 (discussed later) is invoked, wherein the payload data is included in the PDX message, followed by step 702. Otherwise, step 700 invokes step 702.

In step 702, a call is made for PDX services (or, services from an application integration service). Then, in step 704, a determination is made as to whether a status code indicating a valid condition has been returned by the PDX services. If a positive determination is made, process P10 terminates. Otherwise, step 706 is invoked, wherein a determination is made as to whether to re-direct control. If a positive determination is made, step 708 is invoked, wherein control is re-directed to a new request. If a negative determination is made, step 710 is invoked, wherein an error message is displayed. Process P10 then terminates.

FIG. 15k is a flowchart showing additional processing logic of the present invention, indicated generally as process P11. Beginning in step 712, a determination is made as to whether a portal services file has been indicated for retrieval. If a negative determination is made, step 714 is invoked, wherein the file location is set to the application directory. If a positive determination is made, step 716 is invoked, wherein the file location is set to the portal services directory. In step 718, a file type indicator (e.g., XML, XSL, or payload data) is appended to the directory. Then, in step 720, a determination is made as to whether the portal environment is operating in local mode and a session is online. If a negative determination is made, step 728 is invoked, wherein the file is retrieved from the specified directory. Otherwise, step 722 is invoked, wherein a determination is made as to whether the file is a portal services file. If a positive determination is made, step 724 is invoked, wherein the portal services file is downloaded (via the aforementioned HTTPClient module). If a negative determination is made, step 726 is invoked, wherein the application file is downloaded (also via the aforementioned HTTPClient module). Then, step 728, discussed earlier, is invoked.

FIG. 15L is a flowchart showing additional processing logic of the present invention, indicated generally as process P12. Beginning in step 730, a source application name is retrieved from a query string. In step 732, a determination is made as to whether the source application name is numeric. If so, step 734 is invoked, wherein source application information is retrieved, and process P12 then terminates. In the event that a negative determination is made by step 732, step 736 is invoked, wherein a determination is made as to whether the source application name is a primary value. If so, step 738 is invoked, wherein a determination is made as to whether the name is generic. If a positive determination is made, step 740 is invoked, wherein the source application information is retrieved from a configuration file, and process P12 then terminates. If a negative determination is made, step 742 is invoked, wherein source application information is retrieved from a cookie, and process P12 then terminates.

In the event that a negative determination is made in step 736, step 744 is invoked, wherein a determination is made as to whether the application name is generic. If a positive determination is made, step 748 is invoked, wherein the source application is set to the source application name, and process P12 then terminates. Otherwise, step 750 is invoked, wherein source application information is retrieved from the source application name, and the primary value is set to boolean true. Process P12 then terminates.

FIG. 15m is a flowchart showing additional processing logic of the present invention, indicated generally as process P13. Beginning in step 752, a determination is made as to whether the destination type is constant. If a positive determination is made, step 754 is invoked, where a determination is made as to whether the destination name corresponds to the PDX system (or an application integration service). If a positive determination is made, step 756 is invoked, wherein the destination information is set to PDX and process P13 then terminates. If a negative determination is made, step 758 is invoked, wherein a determination is made as to whether the destination name is set to a primary value. If a positive determination is made, step 760 is invoked, wherein a determination is made as to whether the destination name is generic. If a positive determination is made, step 762 is invoked, wherein destination information is retrieved from a configuration file and process P13 then terminates. Otherwise, step 764 is invoked, wherein destination information is retrieved from a cookie and process P13 then terminates. In the event that a negative determination is made by step 758, step 766 is invoked, wherein destination information is retrieved based upon a constant destination name, and process P13 then terminates.

In the event that a negative determination is made by step 752, step 768 is invoked, wherein a determination is made as to whether the destination type is a cookie. If a positive determination is made, step 770 is invoked, wherein the destination information is retrieved based upon a cookie application, and process P13 then terminates. If a negative determination is made, step 772 is invoked, wherein a determination is made as to whether the destination type is a query string. If a negative determination is made, process P13 terminates; otherwise, step 774 is invoked.

In step 774, a loop is initiated for querying a destination string. In step 776, an application value is retrieved form the query string. Then, in step 778, a determination is made as to whether the application value is generic. If a positive determination is made, step 780 is invoked, wherein the destination is set to the destination application. If a negative determination is made, step 782 is invoked, wherein the destination information is retrieved for a query string application. In step 784, a determination is made as to whether other destinations exist. If a positive determination is made, step 774 is re-invoked, so that other destinations can be processed. Otherwise, process P13 terminates.

FIG. 15n is a flowchart showing additional processing logic of the present invention, indicated generally as process P14. Beginning in step 784, a PDX parameter list (or a parameter list for an application integration service) is retrieved for a request. Then, in step 786, a parameter loop is initiated. In step 788, a determination is made as to whether the parameter is a query string parameter. If so, step 790 is invoked, wherein a parameter of a PDX message is set to “QueryString.” Then, step 804 is invoked. In the event that a negative determination is made by step 788, step 792 is invoked, wherein a determination is made as to whether the parameter is a form parameter. If so, step 794 is invoked, wherein a parameter of the PDX message is set to “Form” and step 804 is invoked. Otherwise, step 796 is invoked, wherein a determination is made as to whether the parameter is a cookie parameter. If so, step 798 is invoked, wherein a parameter of the PDX message is set to “Cookie” and step 804 is invoked. Otherwise, step 800 is invoked, wherein a determination is made as to whether the parameter is a constant parameter. If so, step 802 is invoked, wherein a parameter of the PDX message is set to “Constant” and step 804 is invoked. If a negative determination is made in step 800, step 804 is invoked, wherein a determination is made as to whether the last parameter has been processed. If not, parameter processing loop 786 is repeated. If so, process P14 terminates.

FIG. 15o is a flowchart showing additional processing logic of the present invention, indicated generally as process P15. Beginning in step 806, a payload processing loop is initiated. In step 808, a determination is made as to whether the payload is form payload. If a positive determination is made, step 810 is invoked, wherein a form value is loaded into the payload and step 826 is then invoked. Otherwise, step 812 is invoked, wherein a determination is made as to whether the payload is a query string payload. If so, step 814 is invoked, wherein a query string value is loaded into the payload and step 826 is then invoked. Otherwise, step 816 is invoked, wherein a determination is made as to whether the payload is constant payload. If so, step 818 is invoked, wherein a constant value is loaded into the payload and step 826 is then invoked. Otherwise, step 820 is invoked, wherein a determination is made as to whether the payload is generic payload. If so, step 822 is invoked, wherein a payload filename is determined using an entity and an action, and process P17, discussed later, is invoked. Then, step 826 is invoked.

In the event that negative determination is made, step 824 is invoked, wherein a determination is made as to whether the payload is file payload. If a positive determination is made, process P17, discussed later, is invoked, followed by step 826. Otherwise, step 826 is invoked by step 824. In step 826, a determination is made as to whether additional payloads exist. If so, payload processing loop 806 is re-invoked, so that additional payloads can be processed. Otherwise, process P15 terminates.

FIG. 15p is a flowchart showing additional processing logic of the present invention, indicated generally as process P9. Beginning in step 828, an XSL parameter list is retrieved for a request. Then, in step 830, a determination is made as to whether the parameter list contains nothing. If so, process P9 terminates. Otherwise, step 832 is invoked, wherein a parameter processing loop is initiated.

In step 834, a determination is made as to whether the parameter is a query string parameter. If so, step 836 is invoked, wherein a query string parameter is retrieved. Then, step 850 is invoked. In the event that a negative determination is made by step 834, step 838 is invoked, wherein a determination is made as to whether the parameter is a form parameter. If so, step 840 is invoked, wherein a form parameter is retrieved, followed by step 850. Otherwise, step 842 is invoked, wherein a determination is made as to whether the parameter is a cookie parameter. If so, step 844 is invoked, wherein a cookie parameter is retrieved, followed by step 850. Otherwise, step 846 is invoked, wherein a determination is made as to whether the parameter is a constant parameter. If so, step 848 is invoked, wherein a constant parameter is retrieved, followed by step 850. If a negative determination is made in step 846, step 850 is invoked, wherein a determination is made as to whether the last parameter has been processed. If not, parameter processing loop 832 is repeated. If so, process P9 terminates.

FIG. 15q is a flowchart showing additional processing logic of the present invention, indicated generally as process P17. Beginning in step 852, an XML payload file is retrieved. Then, in step 854, a payload item loop is initiated, followed by step 856, wherein the payload item is set. In step 858, a payload object loop is initiated, followed by step 860, wherein the payload object is set. The payload object loop is also accessible from another process at entry point P20. In step 862, a child node loop is initated, and process P18, described later, is invoked. In step 864, a determination is made as to whether additional payload child nodes must be processed. If so, step 862 is re-invoked. Otherwise, step 866 is initiated, wherein a determination is made as to whether additional payload objects must be processed. If so, step 858 is re-invoked. Otherwise, step 868 is invoked, wherein a determination is made as to whether additional payload items must be processed. If a positive determination is made, step 854 is re-invoked; otherwise, process P17 terminates.

FIG. 15r is a flowchart showing additional processing logic of the preset invention, indicated generally as process P18. Beginning in step 870, a child node is analyzed to determine if it is a property (attribute) child node. If so, step 872 is invoked, wherein a payload property value is set and process P18 terminates. Otherwise, step 874 is invoked, wherein a determination is made as to whether the child node is a collection. If so, step 876 is invoked, wherein the payload collection is set. Then, step 880 is invoked, wherein a determination is made as to whether additional child nodes exist. If not, process P18 terminates; otherwise, process P19, described later, is invoked, and process P18 then terminates.

In the event that a negative determination is made by step 874, step 878 is invoked, wherein a determination is made as to whether the child node is an object. If so, entry point P20, discussed earlier, is invoked, and the object is processed in accordance with the present invention. Otherwise, process P18 terminates.

FIG. 15s is a flowchart showing additional processing logic of the present invention, indicated generally as process P19. Beginning in step 882, a child node collection loop is initiated. In step 884, a determination is made as to whether the child node is a property. If so, process P18, discussed earlier, is invoked. Otherwise, step 886 is invoked, wherein a determination is made as to whether the child node is an object. If so, entry point P20, discussed earlier, is invoked. Otherwise, step 888 is invoked, wherein a determination is made as to whether the child node is a collection. If a positive determination is made, process P19 is repeated. Otherwise, step 890 is invoked, wherein a determination is made as to whether additional child nodes exist. If so, step 882 is re-invoked; otherwise, process P19 terminates.

Having thus described the invention in detail, it is to be understood that the foregoing description is not intended to limit the spirit and scope thereof. What is desired to be protected by Letters Patent is set forth in the appended claims.

What is claimed is:

1. A system for providing remote content access comprising:
a portal environment on a computer for displaying content and allowing user interaction;
a portal services module for handling requests for content from the portal environment and delivering content to the portal environment in response to the requests;
a local portal catalog for cataloging content stored locally on the computer; and
a remote portal catalog for cataloging content stored remotely on a server,
wherein the portal services module receives the requests from the portal environment, retrieves a requested file the computer, compares the file to the remote portal catalog to determine whether the file is out of date, downloads a newer version of the requested file from the server if the user is online, and provides the requested file to the user via the portal environment.

2. The system of claim 1, further comprising an application integration services module for integrating local and remote applications, said application integration services module in communication with the portal services module and said local and remote applications accessible via the portal environment,

3. The system of claim 1, wherein the portal environment comprises a portal page displayed in a web browser.

4. The system of claim 1, wherein the portal services module automatically determines whether a user is online or offline.

5. The system of claim 4, wherein the portal services module provides content from the local portal catalog in the portal environment when the user is offline.

6. The system of claim 4, wherein the portal services module downloads the remote portal catalog from the server when the user is online and a request for content is received.

7. The system of claim 1, further comprising an HTTP interface for allowing the computer to be connected to the remote system.

8. The system of claim 1, further comprising XML, XSL, HTML, and portal configuration files for displaying content in the portal environment.

9. The system of claim 8, wherein the XML, XSL, HTML, and portal configuration files are updated by the portal services module in response to user requests in the portal environment.

10. A method for providing content access on a mobile computer comprising:
providing a portal environment on the mobile computer for displaying content and allowing user interaction;
integrating a plurality of multi-vendor applications for use in the portal environment;
allowing a user to utilize the multi-vendor applications and request content in the portal environment;
locating local content corresponding to the user's request;
comparing the content to a remote portal catalog to determine whether the content is out of date;
updating the local content by downloading newer versions of the local content from a remote server; and
displaying the local content in the portal environment.

11. The method of claim 10, further comprising determining whether a user is online or offline.

12. The method of claim 11, further comprising providing downloading the remote portal catalog to the computer if the user is online.

13. The method of claim 10, further comprising allowing the user to access local content from the portal environment when the user is offline.

14. The method of claim 13, further comprising updating local content when the user is next online.

15. A method for dynamically updating content in a portal environment operating on a mobile computer comprising:
receiving a request for content from the portal environment;
determining whether the computer is online or offline;
if the computer is online,
downloading a remote portal catalog from a remote server to the mobile computer;
comparing the local content to the remote portal catalog to determine whether the local content is out of date; and
updating the local content by downloading new versions of the local content from the remote server if the content is out of date;

16. The method of claim 15, wherein the step of determining whether the user is online or offline comprises pinging a server specified in the request.

17. The method of claim 16, further comprising waiting for a response from the server.

18. The method of claim 17, further comprising indicating that the user is online if a response is received from the server.

19. The method of claim 17, further comprising indicating that the user is offline if a response is not received from the server.

20. The method of claim 15, wherein the step of comparing the remote portal catalog to the local content comprises comparing a date entry in the remote portal catalog corresponding to the local content to file dates of the local content.

21. A method of allowing a user to access content in a portal environment comprising:
providing a portal environment on a computer system having a unified look and feel;
allowing the user to interact with the portal environment and request content using the portal environment;
determining whether the user is online or offline;
providing local content in response to the request if the user is offline; and
dynamically updating the local content and providing updated content in response to the request if the user is online.

22. The method of claim 21, further comprising integrating local and remote applications into a unified interface for use in the portal environment.

23. The method of claim 22, further comprising allowing the user to use the unified interface within the portal environment.

24. The method of claim 23, wherein the step of allowing the user to use the unified interface further comprises allowing the user to provide information to and extract information from the local and remote applications using the unified interface.
